(19) United States
(12) Patent Application Publication
(10) Pub. No.: US 2026/0367841 A1
(43) Pub. Date: Nov. 19, 2026

(54) PRINTING SYSTEM, PRINTING METHOD, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Shunsuke YAMAMOTO, Okazaki (JP)

(21) Appl. No.: 19/578,386

(22) Filed: Mar. 25, 2026

(30) Foreign Application Priority Data
May 14, 2025 (JP) 2025-081488

(51) Int. Cl. G06F 3/12

(52) U.S. Cl. CPC G06F 3/1205; G06F 3/1204; G06F 3/1232; G06F 3/1255; G06F 3/1276

(57) ABSTRACT

A printing system comprises a terminal device and a printer. In a case where printing at a document size associated with the image data without using the print setting screen is selected on a print setting screen, the terminal device generates the print setting information for printing at the document size, and in a case where printing at the document size is not selected on the print setting screen, the terminal device generates the print setting information including size information indicating a media size set on the print setting screen.

### REFERENCE TO RELATED APPLICATIONS

This application claims priority under 35 U.S.C. §119 from Japanese Patent Application No. 2025-081488 filed on May 14, 2025. The entire subject matter of the application is incorporated herein by reference.

### BACKGROUND ART

The present disclosure relates to techniques for causing a printer to print an image.

Conventionally, printers have been used for printing images, and various techniques for causing a printer to print images have been proposed. For example, an information processing apparatus causes an image forming apparatus to execute mixed-paper printing of a plurality of pages in which predetermined print settings differ between pages. The information processing apparatus includes a function to acquire intermediate data including the predetermined print settings for the respective pages, a function to determine whether the image forming apparatus has a capability for mixed-paper printing, a generating function to generate print data for causing the image forming apparatus to execute mixed-paper printing based on the intermediate data, and a function to transmit the generated print data to the image forming apparatus. When the image forming apparatus does not have the mixed-paper printing function, the generating function acquires the predetermined print settings included in the intermediate data in the order of the pages to be printed, divides the intermediate data at pages having different predetermined print settings to obtain a plurality of split intermediate data, and generates a plurality of print data based thereon.

### SUMMARY

A printer can print images in various print sizes such as A4 size and Letter size. A print size can be designated by various methods. For example, a user can set a media size on a print setting screen that accepts settings related to printing. Separately from settings via the print setting screen, a media size may be associated with image data; for example, image data of various formats such as Portable Document Format (PDF) may include data indicating a media size. In this configuration, there is room for improvement with respect to using an appropriate size for printing.

The present specification discloses techniques that enable an appropriate size to be used for printing.

According to aspects of the present disclosure, a printing system comprises a terminal device and a printer. The terminal device comprises a display, a display controller configured to cause the display to display a print setting screen configured to receive a print setting, and a transmission controller configured to control transmission of image data to be printed and print setting information indicating the print setting to the printer. The transmission controller is configured to, in a case where printing at a document size is selected on the print setting screen, generate the print setting information for printing at the document size, the document size being a media size associated with the image data without using the print setting screen, the print setting information not including information specifying a media size separately from the document size, and in a case where printing at the document size is not selected on the print setting screen, generate the print setting information including size information indicating a media size set on the print setting screen. The printer comprises a printer engine, and a printing controller configured to cause the printer engine to print an image represented by the image data. In a case where the printer receives, from the terminal device, the image data and the print setting information for printing at the document size and the print setting information does not include the information specifying the media size, the printing controller causes the printer engine to print the image represented by the image data at the document size associated with the image data. In a case where the printer receives, from the terminal device, the image data and the print setting information including the size information indicating the media size set in the print setting screen, the printing controller causes the printer engine to print the image represented by the image data at the media size set in the print setting screen.

According to aspects of the present disclosure, a printing method comprises a display control step of causing a display of a terminal device to display a print setting screen configured to receive a print setting related to printing, a transmission control step of controlling transmission of image data to be printed and print setting information indicating the print setting from the terminal device to a printer, and a printing control step of causing a printer engine of the printer to print an image represented by the image data. In a case where printing at a document size is selected on the print setting screen, the transmission control step includes generating the print setting information for printing at the document size, the document size being a media size associated with the image data without using the print setting screen, the print setting information not including information specifying a media size separately from the document size. In a case where printing at the document size is not selected on the print setting screen, the transmission control step includes generating the print setting information including size information indicating a media size set on the print setting screen. In a case where the printer receives, from the terminal device, the image data and the print setting information for printing at the document size and the print setting information does not include the information specifying the media size, the printing control step includes causing the printer engine to print the image represented by the image data at the document size associated with the image data. In a case where the printer receives, from the terminal device, the image data and the print setting information including the size information indicating the media size set in the print setting screen, the printing control step includes causing the printer engine to print the image represented by the image data at the media size set in the print setting screen.

According to aspects of the present disclosure, a non-transitory computer-readable recording medium contains computer-executable instructions that are executable by a controller of a terminal device. The computer-executable instructions are configured to provide an extended function for a standard driver for printing included in an operating system. The computer-executable instructions are configured to, when executed by the controller, cause the terminal device to perform causing a display of the terminal device to display a print setting screen configured to receive a print setting related to printing, and controlling transmission of image data to be printed and print setting information indicating the print setting to a printer. The computer-executable instructions are further configured to, when executed by the controller, cause the terminal device to perform, in a case where printing at a document size is selected on the print setting screen, generating the print setting information for printing at the document size, the document size being a media size associated with the image data without using the print setting screen, the print setting information not including information specifying a media size separately from the document size, and in a case where printing at the document size is not selected on the print setting screen, generating the print setting information including size information indicating a media size set on the print setting screen.

The techniques disclosed in the present specification can be implemented in various forms. For example, they can be realized as a terminal device for printing, as a system including a terminal device and a printer, as a printing method, as a computer program for implementing functions of such methods or apparatuses, as a program that provides extended functions for a standard driver for printing, or as a computer readable recording medium (for example, a non-transitory recording medium) storing a computer program.

### BRIEF DESCRIPTION OF THE DRAWINGS

FIG. 1 is a block diagram illustrating an example of a system.

FIGS. 2A-C are diagrams illustrating examples of images to be processed.

FIG. 3 is a sequence diagram illustrating an example of a printing process.

FIG. 4 is a sequence diagram illustrating an example of a printing process.

FIG. 5 is a sequence diagram illustrating an example of a printing process.

FIGS. 6A-C are diagrams illustrating examples of setting screens.

FIG. 7 is a flowchart illustrating an example of a process for updating a setting screen.

FIGS. 8A and 8B are diagrams illustrating a second embodiment of a print setting screen.

### DESCRIPTION

### A. First Embodiment

### A1. Apparatus Configuration

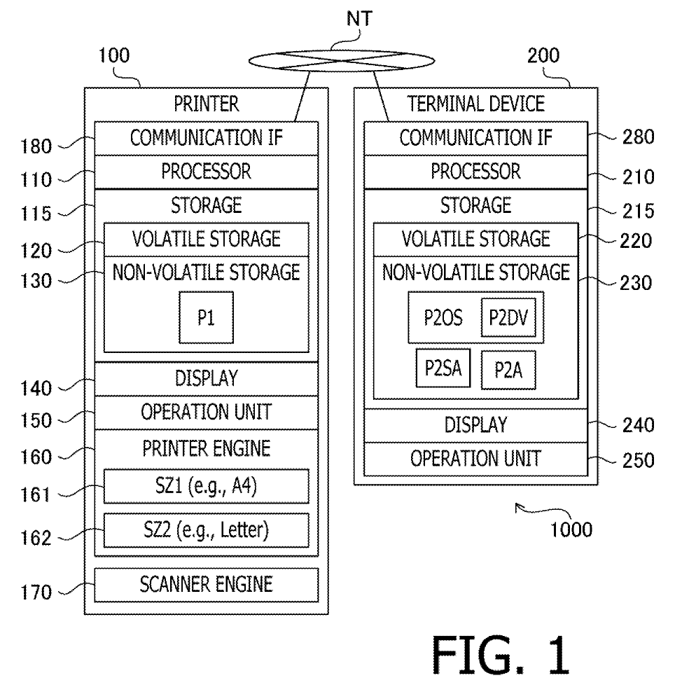

FIG. 1 is a block diagram illustrating an example of a system. A system 1000 includes a printer 100 and a terminal device 200. The printer 100 and the terminal device 200 are connected to a network NT. The network NT may include a so-called local area network. The network NT may also include the Internet.

The printer 100 includes a processor 110, a storage 115, a display 140, an operation unit 150, a printer engine 160, a scanner engine 170, and a communication interface 180. These elements are connected to each other via a bus (not shown). The storage 115 includes a volatile storage 120 and a non-volatile storage 130.

The display 140 is a device configured to display images, such as a liquid crystal display or an organic EL (OLED) display. The operation unit 150 is a device configured to receive operations by a user, such as buttons, levers, or a touch panel disposed so as to overlap the display 140. The display 140 and the operation unit 150 may form a so-called touch screen. A user can input various requests and instructions to the printer 100 by operating the operation unit 150. The display 140 may display operation elements such as buttons or sliders, and the displayed elements may be operated through operations of the operation unit 150.

The printer engine 160 is a device that prints an image on a sheet such as paper. The printer engine 160 may be, for example, an electrophotographic printer engine or an inkjet printer engine. The electrophotographic printer engine may be a so-called laser printer engine. In the present embodiment, the printer engine 160 is assumed to be capable of printing a color image using four colorants: cyan, magenta, yellow, and black.

In the present embodiment, the printer engine 160 includes two trays 161 and 162. The trays 161 and 162 are configured to accommodate sheets having different sizes SZ1 and SZ2, respectively. For example, the first size SZ1 of sheets accommodated in the first tray 161 may be A4 size, and the second size SZ2 of sheets accommodated in the second tray 162 may be Letter size. As described later, the printer 100 prints an image using a sheet having a media size specified for printing.

The scanner engine 170 is a device that optically reads a target object such as a document. The scanner engine 170 includes an optical sensor (not shown). By optically reading the target object, the scanner engine 170 generates scan data of a scan image representing the read target object. The printer including the scanner engine 170 is also referred to as a multifunction peripheral.

The communication interface 180 is an interface for communicating with another device. The communication interface 180 includes, for example, at least one of a USB interface, a wired LAN interface, a wireless interface compliant with IEEE 802.11, and a short-range wireless communication interface. The short-range wireless communication interface may include a Bluetooth (Registered Trademark) interface or a Near Field Communication (NFC) interface. In the present embodiment, the communication interface 180 is connected to the network NT.

The processor 110 is a device configured to perform a data process, and is, for example, a Central Processing Unit (CPU) or a System on a Chip (SoC). The volatile storage 120 is, for example, Dynamic Random Access Memory (DRAM), and the non-volatile storage 130 is, for example, flash memory. The non-volatile storage 130 stores data of a program P1. The program P1 is a program for controlling the printer 100. The data of the program P1 is stored in the non-volatile storage 130 by a manufacturer of the printer 100 at the time of manufacture of the printer 100. The program P1 may alternatively be downloaded from a server (not shown).

In the present embodiment, the program P1 is configured, as a print mode, to process a print job in a so-called pass-through mode. The pass-through mode is a print mode in which image data used for a printing process is transmitted as is to the printer 100. In the present embodiment, the printer 100 is assumed to accept image data in Portable Document Format (PDF) in the pass-through mode. The processor 110, in accordance with the program P1, uses the PDF image data to generate print data for controlling the printer engine 160.

A process for generating the print data includes, for example, a rasterization process, a color conversion process, and a halftoning process. The rasterization process is a process of using the image data to generate raster data at a resolution for printing. A color space of the raster data may be the same as a color space of the image data. For example, the color space of the raster data may be an RGB color space. The color conversion process is a process of converting the color space of the raster data to a colorant color space. The colorant color space is a color space represented by color components of colorants used by the printer engine 160. The colorant color space may be, for example, a CMYK color space. The halftoning process is a process of using the color converted raster data to generate print data indicating, for each colorant and for each pixel, a dot formation state. A method for the halftoning process may be, for example, an error diffusion method or a dithering method.

The processor 110 controls the printer engine 160 in accordance with the print data, thereby printing, on a sheet, a page image represented by the image data.

The PDF image data can set a media size for each page image. The program P1 includes a program for a function of printing each page image on a medium having a corresponding size. For example, the processor 110, by executing pass-through printing, can print a first page image on a medium of Letter size and can print a second page image on a medium of A4 size. Hereinafter, a process of printing respective ones of a plurality of page images on media of mutually different sizes is referred to as “mixed size printing.”

The program P1 may further be configured, as a print mode, to process a print job in a mode that uses image data generated by a printer driver. Hereinafter, this mode is also referred to as a client mode. Image data received in the client mode is not limited to PDF data and may be image data described in various Page Description Languages (PDLs).

The terminal device 200 is a device capable of communicating with another device such as the printer 100. The terminal device 200 may be, for example, a personal computer, a smartphone, or a tablet computer.

The terminal device 200 includes a processor 210, a storage 215, a display 240, an operation unit 250, and a communication interface 280. These elements are connected to each other via a bus (not shown). The storage 215 includes a volatile storage 220 and a non-volatile storage 230.

The display 240 is a device configured to display images. The operation unit 250 is a device configured to receive operations performed by a user. The communication interface 280 is an interface for communicating with another device. Respective configurations of the display 240, the operation unit 250, and the communication interface 280 may be various configurations similar to those described above for the display 140, the operation unit 150, and the communication interface 180 of the printer 100.

The processor 210 is a device configured to perform a data process, and is, for example, a CPU or a SoC. The volatile storage 220 is, for example, Dynamic Random Access Memory (DRAM), and the non-volatile storage 230 is, for example, flash memory. The non-volatile storage 230 stores data of an operating system P2OS, data of a support application P2SA, and data of a document application P2A. The operating system P2OS, the support application P2SA, and the document application P2A are programs executed by the processor 210.

The operating system P2OS may be various systems. In the present embodiment, the operating system P2OS is Windows (Registered Trademark) by Microsoft Corporation. The operating system P2OS may be installed in the terminal device 200 by a manufacturer of the terminal device 200 or by a user of the terminal device 200.

The operating system P2OS includes a class driver P2DV. The class driver P2DV is a class driver for Internet Printing Protocol (IPP). The class driver P2DV is a standard driver commonly usable with multiple types of printers provided by different manufacturers. The standard driver can cause a printer to print an image without installing a dedicated printer driver for the printer. The standard driver can obtain various print settings, such as a media size and a number of copies, through a standard print setting screen.

A support application P2SA provides extended functions for the class driver P2DV. Hereinafter, the support application P2SA is also referred to as a support app P2SA. The support app P2SA can use printer specific functions. For example, the support app P2SA can obtain various print settings through a print setting screen customized for printer specific functions.

The support app P2SA is prepared by a manufacturer of a printer or by a software developer commissioned by the manufacturer. In accordance with an instruction from a user, the support app P2SA may be installed in the terminal device 200. For example, the support app P2SA may be installed by a device addition function of the operating system P2OS. Alternatively, a user may download the support app P2SA from a server (not shown) and manually install the support app P2SA in the terminal device 200.

A document application P2A is an application that processes various document data such as PDF image data and text data. Hereinafter, the document application P2A is also referred to as a document app P2A. The document app P2A may be installed in the terminal device 200 by a manufacturer of the terminal device 200 or by a user of the terminal device 200. Alternatively, the document app P2A may be included in the operating system P2OS.

### A2. Printing Process

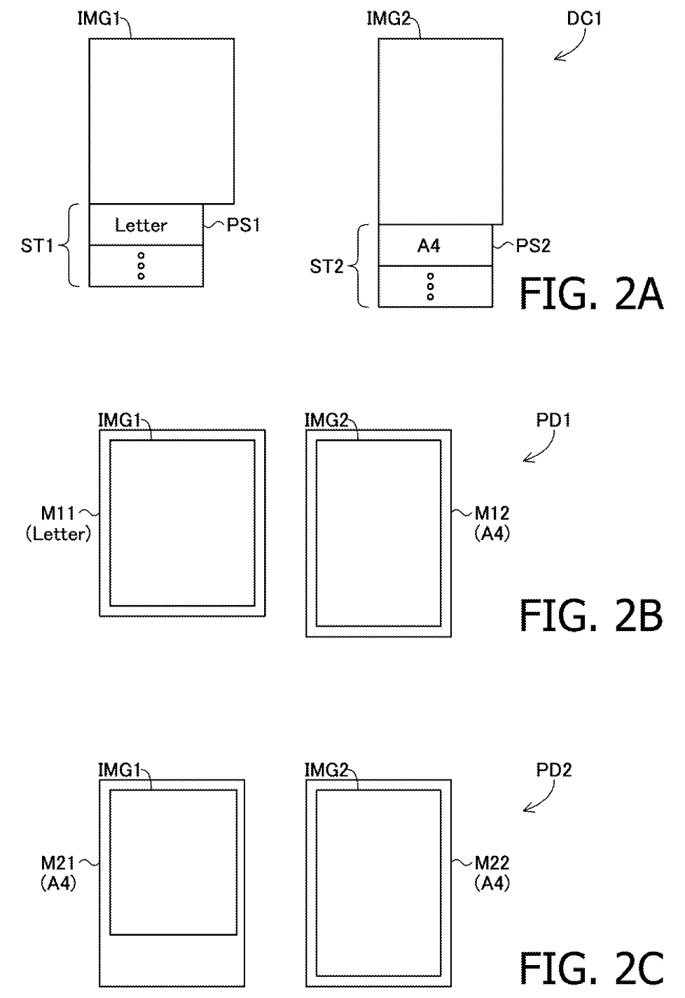

FIGS. 2A-C are diagrams illustrating examples of images to be processed. In the present embodiment, a user uses the document app P2A to cause the printer 100 to print a plurality of page images represented by image data. Hereinafter, image data used for printing process is referred to as input image data. In the present embodiment, the input image data is assumed to be PDF image data. The user is assumed to select a pass-through mode. A method for selecting the pass-through mode may be various. For example, the user may select the pass-through mode through device settings of the printer 100 managed by the operating system P2OS. Alternatively, the user may select the pass-through mode through device settings of the printer 100 managed by the class driver P2DV or by the support app P2SA.

FIG. 2A illustrates a page image represented by input image data. In the present embodiment, input image data DC1 represents two page images IMG1 and IMG2. The PDF image data can represent page settings, which are settings for each page. The page settings are also referred to as attributes. The page settings may include a media size. As the media size, for example, a value associated with a key called “MediaBox” may be used. The MediaBox represents a rectangle that defines a boundary of a physical medium for displaying or printing a page image. Specifically, the MediaBox represents positions of four sides of the rectangle, that is, a height and a width.

In the example of FIG. 2A, a first page setting ST1 associated with a first page image IMG1 includes a media size PS1 that indicates Letter size. A second page setting ST2 associated with a second page image IMG2 includes a media size PS2 that indicates A4 size. Thus, the media size may differ for each page.

The PDF image data may indicate a media size common to a plurality of page images. When a page setting associated with a particular page image among the plurality of page images includes a media size, the media size included in the page setting takes precedence over the common media size.

A media size indicated by the PDF image data is an example of a document size, which is a media size associated with image data without using a print setting screen. In the present embodiment, the document size may indicate a media size for each page image.

When the pass-through mode is selected, the printer 100 shown in FIG. 1 prints each page image in accordance with the document size. For example, when the input image data DC1 of FIG. 2A is used for printing, the printer 100 prints the first page image IMG1 on a Letter size sheet obtained from the second tray 162, and prints the second page image IMG2 on an A4 size sheet obtained from the first tray 161.

Hereinafter, a process of printing respective ones of a plurality of page images on media having sizes indicated by the document size is referred to as “document size printing.” In the present embodiment, a media size indicated by the document size may differ among the plurality of page images. By executing the document size printing, mixed size printing may be executed. In the present embodiment, when the printer is capable of executing the mixed size printing, the printer is assumed to be capable of executing the document size printing. When the printer cannot execute the mixed size printing, the printer cannot execute the document size printing. A process of printing each page image in accordance with the media size indicated by PDF image data is an example of the document size printing.

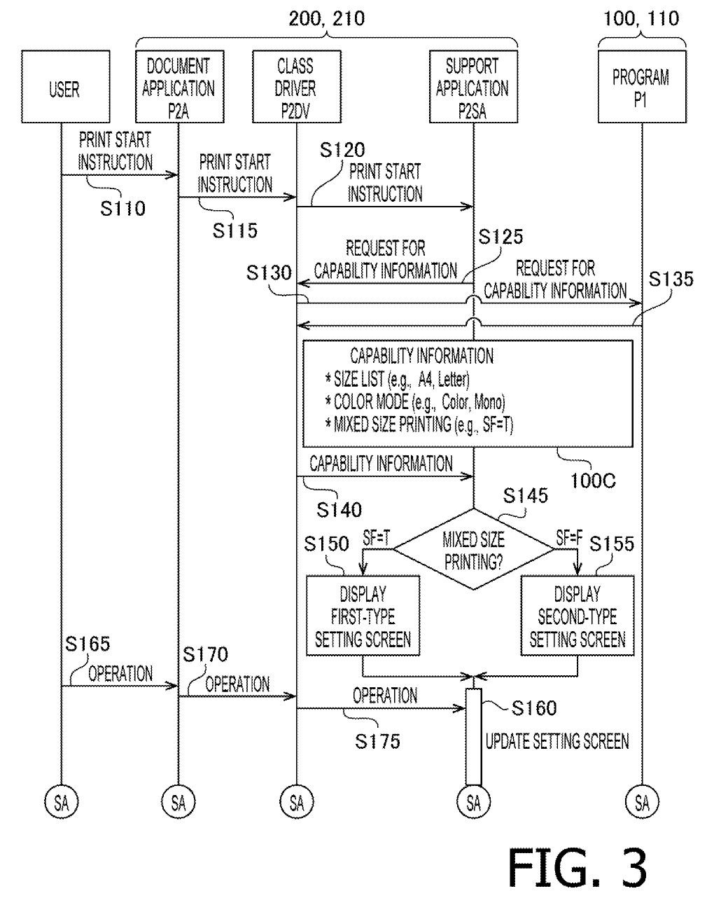

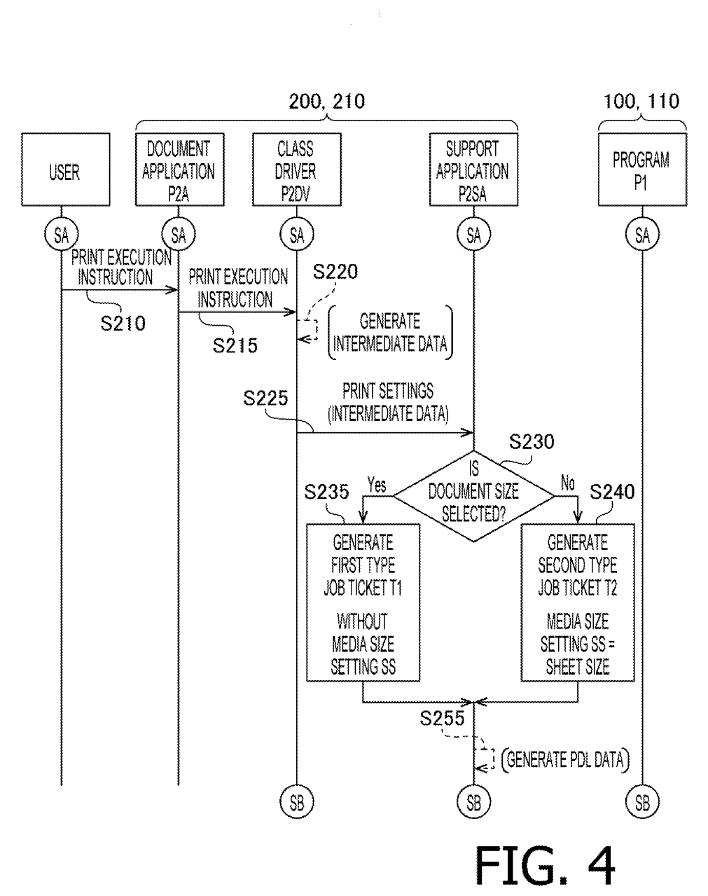

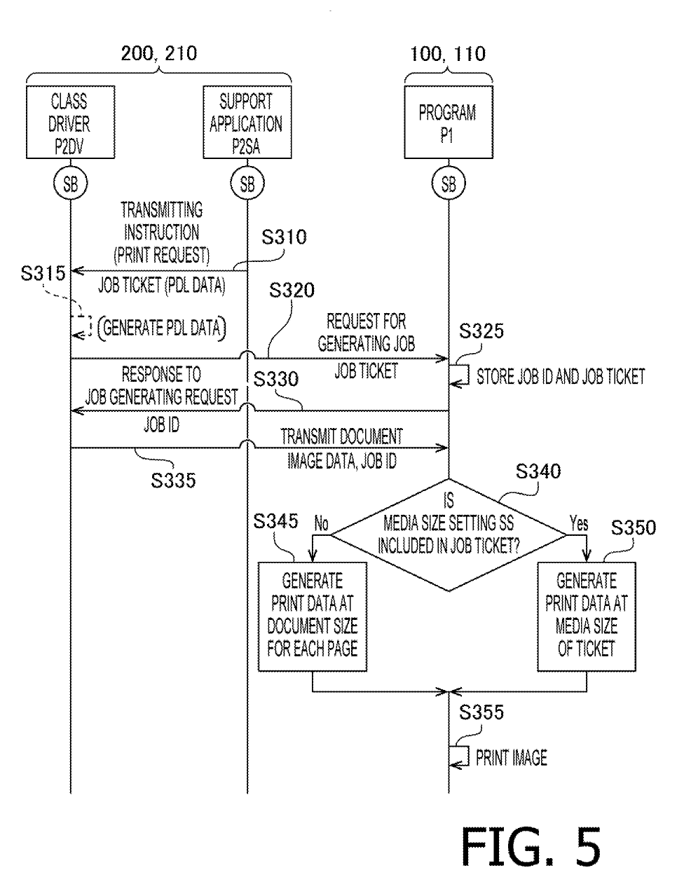

FIGS. 3, 4, and 5 are sequence diagrams illustrating examples of the printing process. FIG. 4 illustrates processes subsequent to FIGS. 3 and 5 illustrates processes subsequent to FIG. 4. In the diagrams, programs P2A, P2DV, P2SA, and P1 are indicated. The processor 210 of the terminal device 200 executes processes in accordance with the programs P2A, P2DV, and P2SA. Hereinafter, execution of processes by the processor 210 in accordance with the document application P2A is also expressed as “the document app P2A executes the processes.” The same applies to the class driver P2DV and the support application P2SA. A processor 110 of a printer 100 executes processes in accordance with a program P1. Hereinafter, the processor 110 of the printer 100 is also referred to as “the printer processor 110.”

Here, it is assumed that the input image data DC1 of FIG. 2A has already been opened by the document app P2A. In S110 of FIG. 3, a user inputs a print start instruction to the document app P2A by operating an operation unit 250 of the terminal device 200. In S115, the document app P2A supplies the print start instruction to the class driver P2DV. In S120, the class driver P2DV supplies the print start instruction to the support app P2SA.

In S125, the support app P2SA supplies a request for capability information to the class driver P2DV. As described later, the capability information represents all functions executable by the printer. In S130, in response to the request from the support app P2SA, the class driver P2DV supplies the request for the capability information to the printer 100. In S135, the printer processor 110, in response to the request, supplies data of capability information of the printer 100 to the terminal device 200.

An example of the capability information is illustrated in the diagram. In the present embodiment, the capability information 100C represents various information including a list of available media sizes, a list of available color modes, and a mixed size flag SF that indicates whether the mixed size printing is executable. Hereinafter, it is assumed that the list of available media sizes includes “A4” and “Letter,” and that the list of available color modes includes “color” and “monochrome.” The mixed size flag SF is selected from T (executable) and F (not executable). In the present embodiment, the mixed size flag SF indicates T.

In S140, the class driver P2DV supplies the capability information 100C acquired from the printer 100 to the support app P2SA. In subsequent S145 to S155, the support app P2SA causes the display 240 to display a print setting screen that allows a user to select print settings to be used for printing from among available print settings. The available print settings are represented by the capability information 100C.

In S145, the support app P2SA refers to the capability information 100C to determine whether the mixed size printing can be executed. When the mixed size flag SF indicates T, in S150, the support app P2SA causes the display 240 to display a first type print setting screen. The support app P2SA may cause the display 240 to display the print setting screen using a function of the class driver P2DV. Alternatively, the support app P2SA may cause the display 240 to display a setting screen without using a function of the class driver P2DV. Hereinafter, the print setting screen is also referred to simply as “the setting screen.” The first type print setting screen is also referred to as “the first-type setting screen.”

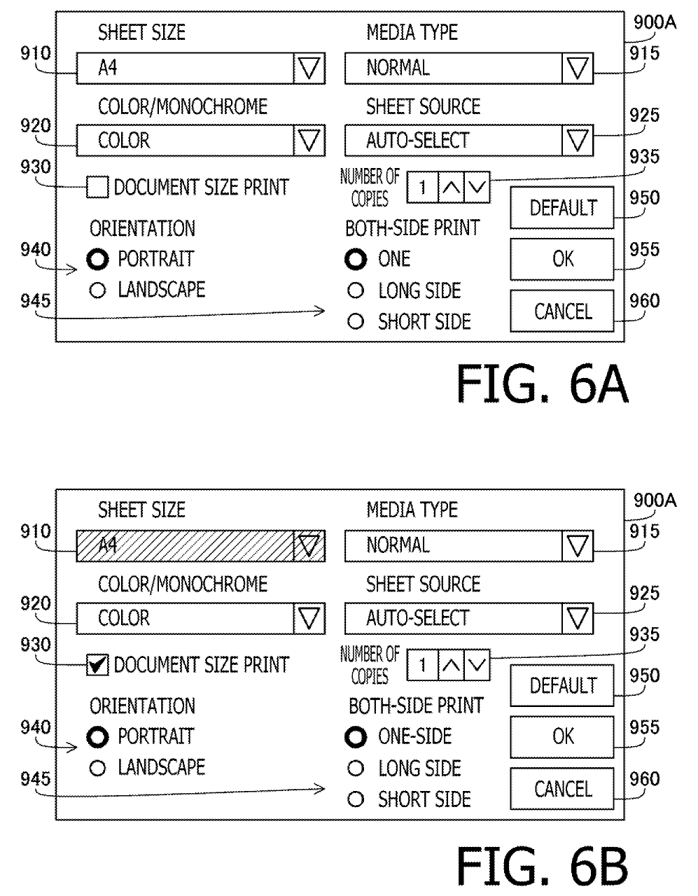

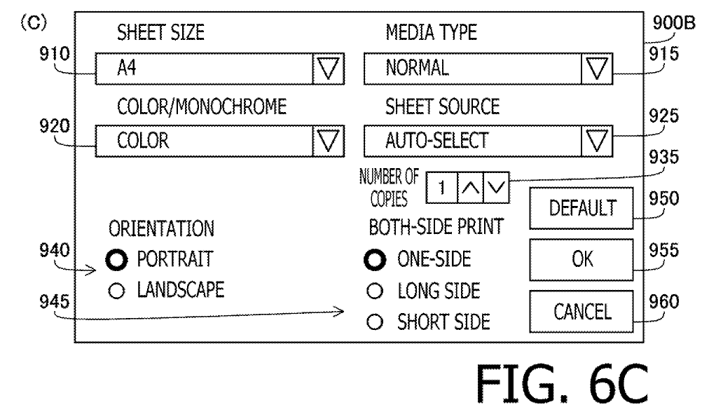

FIGS. 6A-C are diagrams illustrating examples of setting screens. A setting screen includes various operation elements such as dropdown menus and buttons. A user can edit print settings by operating the operation elements.

FIG. 6A illustrates a first-type setting screen displayed in S150 of FIG. 3. The first-type setting screen 900A includes the dropdown menus 910, 915, 920, and 925, a checkbox 930, a spinner 935, radio button groups 940 and 945, and buttons 950, 955, and 960. Hereinafter, the dropdown menus 910, 915, 920, and 925 are also referred to simply as the menus 910, 915, 920, and 925.

The menu 910 allows a user to select one sheet size from a list of sheet sizes. In the present embodiment, the list includes “A4” and “Letter.”

The menu 915 allows a user to select one media type from a list of media types. The list includes, for example, “normal paper” and “glossy paper.”

The menu 920 allows a user to select one color mode from a list of color modes. In the present embodiment, the list includes “color” and “monochrome.”

The menu 925 allows a user to select one paper source from a list of paper sources. In the present embodiment, the list includes “automatic selection,” “the first tray 161,” and “the second tray 162.”

The checkbox 930 allows a user to select document size printing. As described later, when the checkbox 930 is in a checked state, a sheet size selected via the menu 910 is not referenced, and a document size is used for printing. When the checkbox 930 is not checked, the document size is not referenced, and the sheet size selected via the menu 910 is used for printing.

The spinner 935 allows a user to set the number of copies to be printed.

The radio button group 940 allows a user to select an orientation of an image from “portrait” and “landscape.”

The radio button group 945 allows a user to select a duplex printing (i.e., both-side printing) setting from “one side,” “long side,” and “short side.” The “long side” is duplex printing in which a hinge for page turning corresponds to a long edge, and the “short side” is duplex printing in which the hinge corresponds to a short edge.

The button 950 is a button for returning changeable settings to predetermined initial settings.

The button 955 is a button for finishing the settings and executing printing.

The button 960 is a button for interrupting the printing process.

As described above, the print settings selectable through the first-type setting screen 900A are print settings represented by the capability information 100C.

After the display of the setting screen in S150 of FIG. 3, the support app P2SA executes an updating process for the setting screen in S160. For input or modification of print settings, a user operates operation elements included in the setting screen by operating the operation unit 250 of the terminal device 200. The support app P2SA updates the setting screen in response to the user operation. For example, in S165, the user operates an operation element. The operation content may be received by the document app P2A and transmitted to the support app P2SA via the class driver P2DV (S170 and S175). Alternatively, the operation content may be accepted by the class driver P2DV without through the document app P2A, or may be accepted by the support app P2SA without through either the document app P2A or the class driver P2DV.

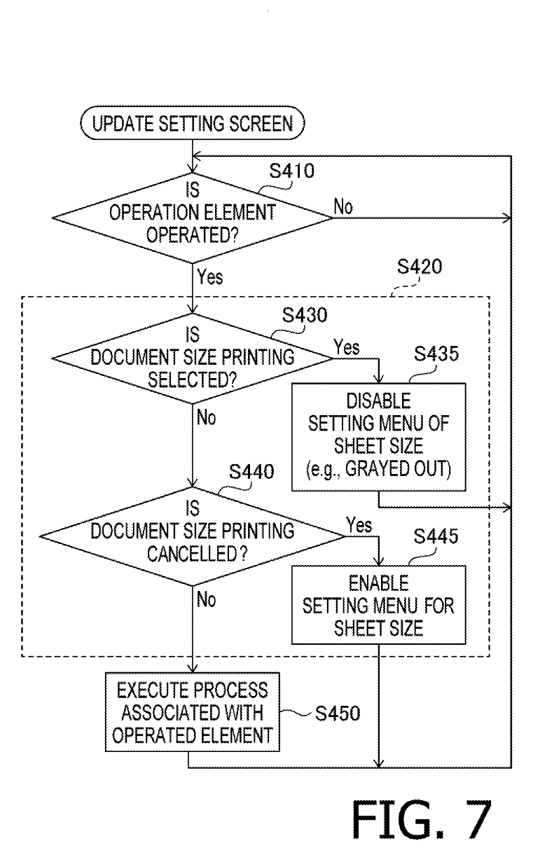

FIG. 7 is a flowchart illustrating an example of the updating process for the setting screen. In S410, the support app P2SA determines whether an operation element has been operated. When no operation element has been operated (S410: No), the support app P2SA waits for operation of an operation element.

When the operation element has been operated (S410: Yes), in S430, the support app P2SA determines whether document size printing is selected by the operation of the operation element. In the present embodiment, when a state of the checkbox 930 in FIG. 6A changes from an unchecked state to a checked state, the determination result is Yes. In this case, in S435, the support app P2SA disables a setting menu for a sheet size. FIG. 6B illustrates an example of the first-type setting screen 900A updated in S435 of FIG. 7. In the present embodiment, the support app P2SA does not delete the menu 910 for selecting a sheet size from the first-type setting screen 900A, but instead grays out the menu 910. By observing the first-type setting screen 900A, a user can recognize that selection via the menu 910 is not used for printing. After S435 of FIG. 7, the support app P2SA proceeds to S410.

When the determination result in S430 is No, in S440, the support app P2SA determines whether selection of the document size printing is canceled by the operation of the operation element. In the present embodiment, when a state of the checkbox 930 in FIG. 6B changes from the checked state to the unchecked state, the determination result is Yes. In this case, in S445, the support app P2SA enables the setting menu for a sheet size. As a result, a state of the menu 910 of the first-type setting screen 900A returns from the state of FIG. 6B to the state of FIG. 6A. After S445 of FIG. 7, the support app P2SA proceeds to S410.

When the determination result in S440 is No, in S450, the support app P2SA executes processing associated with the operated element. For example, when the button 950 in FIGS. 6A and 6B is operated, the support app P2SA returns settings of the respective operation elements to initial settings. When the button 960 is operated, the support app P2SA terminates the printing process.

After completion of editing of the print settings, in S210 of FIG. 4, the user inputs a print execution instruction by operating the operation unit 250 of the terminal device 200. In the present embodiment, the button 955 in FIGS. 6A and 6B is a button for inputting the print execution instruction. By operating the button 955, the user inputs the print execution instruction. The print execution instruction may be received by the document app P2A and transmitted to the class driver P2DV (S215). Alternatively, the print execution instruction may be received by the class driver P2DV without through the document app P2A.

In response to the print execution instruction, the class driver P2DV starts processing for executing printing. S220 is a step that may be executed when a print mode is the client mode, as described later.

In S225, the class driver P2DV notifies the support app P2SA of all print settings set through the setting screen.

In S230, the support app P2SA determines whether the document size printing is selected by the print settings. When the document size printing is selected (S230: Yes), in S235, the support app P2SA generates a first type job ticket T1. A job ticket represents print settings of a print job supplied to the printer 100. In S235, the support app P2SA generates the job ticket representing remaining print settings other than a sheet size among all print settings set through the setting screen. The first type job ticket T1 does not include an item related the sheet size.

When the document size printing is not selected (S230: No), in S240, the support app P2SA generates a second type job ticket T2. In S240, the support app P2SA generates a job ticket that represents all print settings set through the setting screen. For example, the second type job ticket T2 includes a media size setting SS. The media size setting SS indicates a sheet size selected via the menu 910 included in the first-type setting screen 900A of FIG. 6A.

After S235 or S240 of FIG. 4, the support app P2SA proceeds to S310 of FIG. 5. It should be noted that S255 of FIG. 4 may be executed when a print mode is the client mode, as described later.

In S310 of FIG. 5, the support app P2SA supplies a print request to the class driver P2DV. The print request includes the job ticket generated in S235 or S240 of FIG. 4. S310, which follows S310, may be executed when the print mode is the client mode, as described later.

In S320, in response to the request in S310, the class driver P2DV transmits to the printer 100 a request for job generation. This request includes data of the job ticket obtained in S310.

In S325, the printer processor 110 generates a job ID associated with the job ticket. The printer processor 110 stores, in the storage 115, the job ticket data in association with the job ID data. The data may be stored in, for example, the non-volatile storage 130.

In S330, the processor 110 transmits, to the terminal device 200, a response to the request for job generation. The response includes data of the job ID.

In S335, the class driver P2DV performs document transmission. In the present embodiment, the class driver P2DV transmits to the printer 100 an image data set including the image data and the job ID data. When the print mode is the pass-through mode, the class driver P2DV transmits to the printer 100 input image data such as the input image data DC1 of FIG. 2A. The input image data transmitted in S335 is an example of target image data that is image data to be printed.

In S340, the printer processor 110 determines whether a job ticket associated with the job ID obtained in S335 includes information indicating a media size. In the present embodiment, when the job ticket includes the media size setting SS, the determination result is Yes. That is, when the job ticket is generated in S235 of FIG. 4, the job ticket does not include the media size setting SS and therefore the determination result is No, whereas when the job ticket is generated in S240, the determination result is Yes.

When the determination result in S340 is No, in S345, the printer processor 110 generates print data based on a document size. The printer processor 110 uses the image data obtained in S335 and the job ticket associated with the job ID obtained in S335. When the print mode is the pass-through mode, the image data is the input image data. The printer processor 110 sets, for each page image, a media size to a per page media size indicated by the image data, and sets print settings other than the media size to print settings represented by the job ticket.

In S355, the printer processor 110 controls the printer engine 160 in accordance with the print data, thereby printing the respective page images. Thereafter, the printing process is terminated.

FIG. 2B is a diagram illustrating an example of a printed material printed using the print data generated in S345 of FIG. 5. The printed material PD1 represents a printed material printed using the input image data DC1 of FIG. 2A. The printed material PD1 includes the media M11 and M12. The first page image IMG1 is printed on the medium M11, and the second page image IMG2 is printed on the medium M12. A size of the medium M11 representing the first page image IMG1 is the Letter size indicated by the media size PS1, and a size of the medium M12 representing the second page image IMG2 is the A4 size indicated by the media size PS2. Thus, the mixed size printing is executed through the document size printing.

When a determination result in S340 of FIG. 5 is Yes, in S350, the printer processor 110 generates print data using the media size indicated by the media size setting SS included in a job ticket. Unlike S345, the printer processor 110 sets all print settings to those represented by the job ticket. The printer processor 110 sets, for each page image, the media size to the media size indicated by the media size setting SS. After S350, the printer processor 110 proceeds to S355.

FIG. 2C is a diagram illustrating an example of a printed material printed using the print data generated in S350 of FIG. 5. The printed material PD2 represents a printed material printed using the input image data DC1 of FIG. 2A. Here, it is assumed that the media size indicated by the job ticket is the A4 size. The printed material PD2 includes the A4-size media M21 and M22. The first page image IMG1 is printed on the medium M21, and the second page image IMG2 is printed on the medium M22. Thus, all of the page images IMG1 and IMG2 are printed on media having the media size indicated by the job ticket, that is, the media size selected via the menu 910 of FIG. 6A.

When the media size indicated by the job ticket differs from the media size indicated by the document size, the printer processor 110 may enlarge or reduce a page image in such a manner that the page image fits within the media size indicated by the job ticket.

When the mixed size flag SF indicates F in S145 of FIG. 3, in S155, the support app P2SA causes a second-type setting screen to be displayed on the display 240. FIG. 6C is a diagram illustrating an example of a second-type setting screen 900B. A difference between the second-type setting screen 900B of FIG. 6C and the first-type setting screen 900A of FIGS. 6A and 6B is only that the checkbox 930 is omitted. When the mixed size flag SF indicates F, the printer cannot execute the document size printing that includes mixed size printing. In this case, it is prevented that a user erroneously checks the checkbox 930.

Processes subsequent to S155 of FIG. 3 are the same as that when the mixed size flag SF indicates T. In S160, the support app P2SA executes the process of FIG. 7. When the mixed size flag SF indicates F, the support app P2SA may omit S420 including S430 to S445 of FIG. 7. When a determination result in S410 is Yes, the support app P2SA may proceed to S450. Further, a determination result in S230 of FIG. 4 is No, and a determination result in S340 of FIG. 5 is Yes. As illustrated in FIG. 2C, all of the page images IMG1 and IMG2 are printed on media having the media size indicated by the job ticket, that is, the media size selected via the menu 910 of FIG. 6C.

When the print mode is not the pass-through mode but the client mode, PDL data is generated by the class driver P2DV or by the support app P2SA, as described below.

In S220 of FIG. 4, the class driver P2DV may generate intermediate data using the input image data. The intermediate data may be, for example, XPS data. In S225, the class driver P2DV may further supply the intermediate data to the support app P2SA. In S255, the support app P2SA may generate PDL data using the intermediate data. The PDL data is generated in accordance with the print settings based on the first-type setting screen 900A of FIGS. 6A and 6B or the setting screen 900B of FIG. 6C. Here, the support app P2SA may generate the PDL data without using a function of the operating system P2OS. Alternatively, the support app P2SA may generate the PDL data using a function of the operating system P2OS. The print request of S310 of FIG. 5 may include information indicating that generation of the PDL data by the class driver P2DV is unnecessary and may include the PDL data.

Alternatively, the class driver P2DV may generate the PDL data instead of the support app P2SA. In this case, the transmission of the intermediate data in S225 of FIG. 4 and S255 are omitted, and the print request of S310 of FIG. 5 may include an instruction to generate the PDL data. In S315, the class driver P2DV generates the PDL data in accordance with the instruction.

In either case, in S335, the class driver P2DV transmits the PDL data to the printer 100. The PDL data transmitted in S335 is an example of target image data, which is image data to be printed. The PDL data, similarly to the PDF image data, may indicate a document size and may represent a plurality of page images of mixed sizes. The printer processor 110 executes S340 to S355 of FIG. 5 using the job ticket and the PDL data.

The input image data used for the printing process may be arbitrary image data instead of PDF image data. For example, a document edited by a word processor application may be printed. In this case, the printing process may proceed in a client mode. Here, the word processor application may edit a document that represents a plurality of page images with mixed media sizes. The page Description Language (PDL) data generated by the printing process may represent the plurality of page images with mixed media sizes.

As described above, in the present embodiment, the system 1000 of FIG. 1 includes the terminal device 200 and the printer 100. The terminal device 200 includes the display 240 and the processor 210. The processor 210, in accordance with the support application P2SA, executes the following processes. In S150 of FIG. 3, the processor 210 causes the display 240 display the first-type setting screen 900A of FIG. 6A. The first-type setting screen 900A is an example of a print setting screen configured to receive settings related to printing. The processor 210 that executes S150 is an example of a display controller configured to cause the display 240 to display the print setting screen 900A.

When a determination result in S230 of FIG. 4 is Yes, that is, when document size printing is selected on the setting screen 900A of FIG. 6B, the processor 210 executes S235. The document size printing is printing at a “document size,” which is a media size associated with image data without using the print setting screen. The media sizes PS1 and PS2 shown in FIG. 2A are examples of the document size. In S235, the processor 210 generates a first type job ticket T1. The first type job ticket T1 represents print settings and is an example of print setting information for printing at the document size. The first type job ticket T1 does not include a media size setting SS; that is, the first type job ticket T1 is print setting information that does not include information specifying a media size separately from the document size.

When the determination result in S230 of FIG. 4 is No, that is, when the document size printing is not selected on the setting screen 900A of FIG. 6A, the processor 210 executes S240. In S240, the processor 210 generates a second type job ticket T2. The second type job ticket T2 includes a media size setting SS. The media size setting SS indicates a sheet size selected via the menu 910 on the setting screen 900A. The media size setting SS is an example of size information indicating a media size that is set on the print setting screen. The second type job ticket T2 is an example of print setting information including the size information.

The first type job ticket T1 or the second type job ticket T2 is transmitted to the printer 100 in S320 of FIG. 5. The input image data DC1, which is an example of target image data, is transmitted to the printer 100 in S335. The class driver P2DV performs S320 and S335 in response to a request in S310. Thus, a print request in S310 is an example of an instruction to transmit the input image data DC1 and a job ticket to the printer 100.

The processor 210 that executes S230, S235, S240, and S310 in accordance with the support app P2SA is an example of a transmission controller configured to control transmission to the printer 100 of the input image data DC1 and the job ticket representing the print settings.

The printer 100 includes the printer engine 160 and the processor 110. The processor 110, in accordance with a program P1, executes the following processes. In S340 to S355 of FIG. 5, the processor 110 causes the printer engine 160 to print images IMG1 and IMG2 represented by the input image data DC1. The processor 110 that executes S340 to S355 is an example of a printing controller that causes the printer engine to print an image represented by image data.

When, in S320 and S335, the printer 100 receives the input image data DC1 and the first type job ticket T1 from the terminal device 200, a determination result in S340 is No. In this case, the printer processor 110 executes S345 and S355. In S345 and S355, the processor 110 causes the printer engine 160 to print the images IMG1 and IMG2 represented by the input image data DC1 at the document size associated with the input image data DC1.

When, in S320 and S335, the printer 100 receives the input image data DC1 and the second type job ticket T2 from the terminal device 200, the determination result in S340 is Yes. In this case, the processor 110 executes S350 and S355. In S350 and S355, the processor 110 causes the printer engine 160 to print the images IMG1 and IMG2 represented by the input image data DC1 at the media size indicated by the media size setting SS included in the second type job ticket T2.

According to this configuration, the system 1000 can use, for printing, an appropriate size from among a document size, which is a media size associated with the input image data DC1 without using the print setting screen, and a media size set on the print setting screen 900A.

In the present embodiment, the processor 210, in accordance with the support app P2SA, executes the following processes. In S125 of FIG. 3, the processor 210 supplies a request for capability information to the class driver P2DV. The capability information represents capabilities of the printer 100 related to printing. In S140, the processor 210 acquires the capability information from the class driver P2DV. Thus, in accordance with the support app P2SA, the processor 210 acquires the capability information from the printer 100 via the class driver P2DV. The processor 210 that executes S125 and S140 is an example of an acquisition unit configured to acquire the capability information from the printer 100.

The processor 210, in accordance with the support app P2SA, executes S145 and S150 of FIG. 3. When the capability information indicates that the printer 100 can execute printing at the document size, the process proceeds from S145 to S150. In S150, the processor 210 causes the display 240 to display the first-type setting screen 900A of FIG. 6A. The first-type setting screen 900A includes the operation element 930 for selecting the document size printing. Thus, the processor 210 allows a user to select the printing at the document size on the print setting screen 900A. According to this configuration, when the printer 100 can execute the document size printing, the system 1000 can allow a user to select the document size printing.

In the present embodiment, in S150 of FIG. 3, the processor 210 causes the display 240 to display the print setting screen 900A of FIG. 6A, which includes the checkbox 930 for selecting the printing at the document size. According to this configuration, a user can easily select the document size printing.

In the present embodiment, in S150 of FIG. 3, the processor 210 causes the display 240 to display the print setting screen 900A of FIG. 6A, which includes the menu 910. The menu 910 is an example of a size setting part that accepts a setting of a media size. After S150, the processor 210 executes S160, which updates the setting screen in accordance with the support app P2SA. S160 includes S430 and S435 of FIG. 7. When the printing at the document size is selected by the checkbox 930, a determination result in S430 is Yes. In this case, in S435, the processor 210 disables the menu 910 without deleting the menu 910. According to this configuration, when the document size printing is selected, the processor 210 can allow a user to easily recognize that the selection of the sheet size via the menu 910 is not used for printing. The processor 210 that executes S150, S430, and S435 is an example of a display controller that performs display and updating of the print setting screen.

In the present embodiment, as described in S235 of FIG. 4, the first type job ticket T1 does not include the media size setting SS. Accordingly, when the document size printing is selected, the possibility that a media size other than the document size is erroneously used is reduced.

In the present embodiment, as described in S320 and S335 of FIG. 5, transmission of the input image data DC1 and a job ticket is performed by a process of transmitting the job ticket to the printer 100 in S320 and a process of transmitting, to the printer 100, an image data set including the input image data DC1 in S335. The document size is represented by the image data set including the input image data DC1. Thus, since the job ticket and the image data set are transmitted separately, the printer 100 can easily distinguish between the job ticket and the image data set. Further, the possibility that information included in the job ticket is erroneously used as the document size is reduced.

The transmission of data of the job ticket may be executed after transmission of the image data. In either case, it is preferable that transmission of later data starts after transmission of earlier data is completed.

In the present embodiment, the terminal device 200 of FIG. 1 includes the operating system P2OS including the class driver P2DV and the support app P2SA that provides extended functions for the class driver P2DV. The function for providing the first-type setting screen 900A of FIGS. 6A and 6B, which includes the checkbox 930, and the function for executing S230 to S240 of FIG. 4 and S430 to S445 of FIG. 7 based on the operation state of the checkbox 930 are examples of extended functions provided by the support app P2SA. The class driver P2DV is an example of a standard driver for printing. In S310 of FIG. 5, the support app P2SA, as the transmission controller described above, instructs the standard driver to transmit the input image data DC1 and the job ticket to the printer 100. According to this configuration, the support app P2SA can appropriately control transmission of the input image data DC1 and the job ticket to the printer 100 via the class driver P2DV.

### B. Second Embodiment

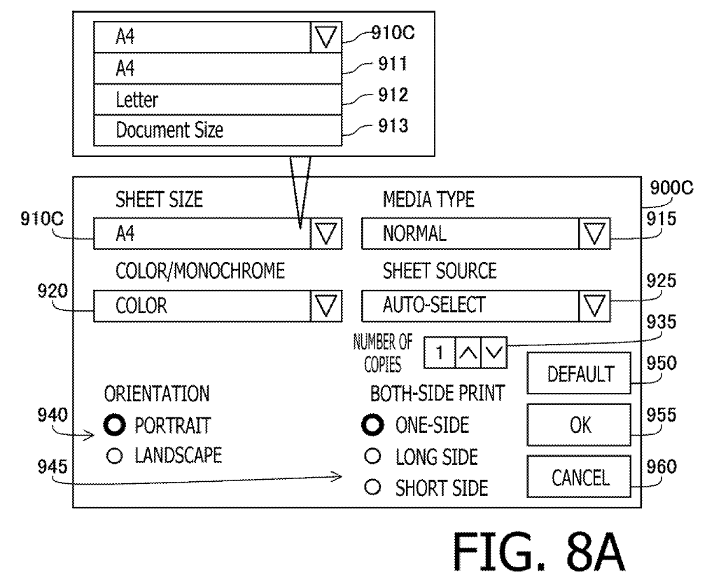

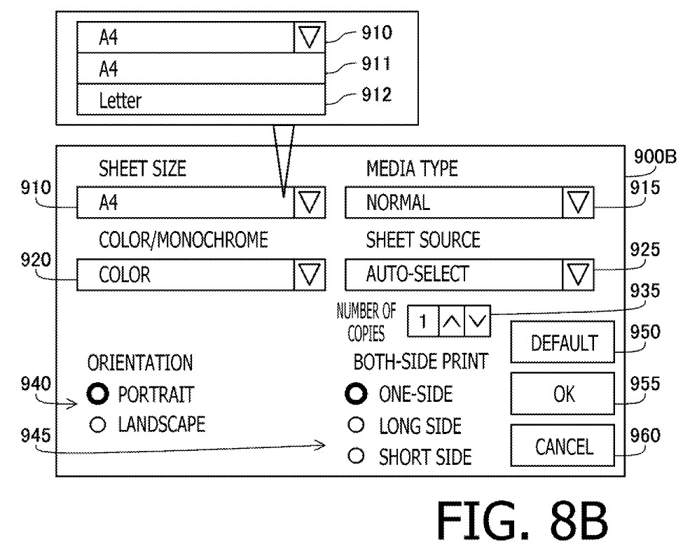

FIGS. 8A and 8B are diagrams illustrating a second embodiment of a print setting screen. FIG. 8A illustrates a first-type setting screen 900C displayed in S150 of FIG. 3. A difference between the first-type setting screen 900C of FIG. 8A and the first-type setting screen 900A of FIG. 6A is that the checkbox 930 is omitted and the menu 910 is replaced with a menu 910C. FIG. 8A illustrates a list of sheet sizes displayed through an operation of the menu 910C. The list includes an option 911 indicating A4 size, an option 912 indicating Letter size, and an option 913 indicating document size printing. A user can select the document size printing by selecting the option 913.

FIG. 8B illustrates a second-type setting screen 900B displayed in S155. The second-type setting screen 900B is the same as the second-type setting screen 900B of FIG. 6C. FIG. 8B illustrates, for comparison with FIG. 8A, a list of sheet sizes displayed through an operation of the menu 910. The list includes the option 911 indicating A4 size and the option 912 indicating Letter size. The option 913 indicating document size printing is not included in the list. A user can select either A4 or Letter.

As described above, in the present embodiment, in S150 of FIG. 3, the processor 210 causes the display 240 to display a first-type setting screen 900C including the menu 910C of FIG. 8A. The menu 910C is a dropdown menu and is an example of a selection part that allows a user to select an option. The menu 910C represents multiple options 911-913 including media size options 911 and 912 and an option 913 indicating document size printing. Thus, because a single operation element 910C represents the options 911-913 related to media sizes, a user can easily select a particular media size or the document size printing.

A method for realizing switching between the first-type setting screen 900C and the second-type setting screen 900B may be modified. For example, when the printer can execute the document size printing, the capability information 100C transmitted in S135 of FIG. 3 may include a list of media sizes including A4, Letter, and the document size. The mixed size flag SF may be omitted. S145 may be omitted. The support app P2SA may set a list for the menu 910 in accordance with the list of media sizes included in the capability information 100C. As a result, either the first-type setting screen 900C or the second-type setting screen 900B is displayed.

While the embodiment has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described embodiment are provided below:

### C. Modifications

The above embodiments are applicable to various modifications described below.

(1) The document size may be represented by data associated with image data instead of by the image data itself. For example, metadata representing attribute information regarding the image data may represent the document size. In this case, in the printing processes of FIGS. 3-5, a set of the image data and the metadata is processed instead of the image data alone. For example, in S335 of FIG. 5, the class driver P2DV transmits to the printer 100 an image data set including the image data, the metadata, and job ID data.

In any case, the document size may be various media sizes associated with image data without using the print setting screen. Methods for associating a media size with image data without using a print setting screen may be various. For example, an application that edits data representing page images, such as PDF image data or document data, may assign a media size to each page image.

The document size may represent a single media size common to all page images represented by the image data. In this case, even when a printer cannot execute the mixed size printing, the printer can execute the document size printing. The capability information transmitted in S135 of FIG. 3 may include, instead of the mixed size flag SF, a document flag indicating whether the document size printing is executable. In S145, the support app P2SA determines whether the document size printing is executable by referring to the document flag. When the document size printing is executable, the support app P2SA executes S150; when the document size printing is not executable, the support app P2SA executes S155.

(2) Print setting information for the document size printing is not limited to the first type job ticket T1 described in S235 of FIG. 4, and may be various print setting information that does not include information specifying the media size separately from the document size. For example, the printer may be configured to use a default media size when the job ticket does not include the media size setting SS. The job ticket may omit the media size setting SS and may include information indicating that the default media size is not to be used. When the printer 100 receives such a job ticket from the terminal device 200, the printer processor 110 may execute the document size printing.

Alternatively, the job ticket may include the media size setting SS and information indicating that the media size setting SS is invalid. In this case, because the media size setting SS is invalidated, the media size setting SS does not specify the media size. Such a job ticket is an example of print setting information that does not include information specifying the media size separately from the document size.

(3) The printing process may be other various processes instead of the processes described with reference to FIGS. 3-7. For example, image data transmitted from the terminal device 200 to the printer 100 may be raster data. S125 to S145 and S155 of FIG. 3 may be omitted. In response to the print start instruction of S120, the support app P2SA may execute S150.

When the first-type setting screen 900A of FIG. 6A is displayed, S430 to S445 of FIG. 7 may be omitted. That is, the graying out of the menu 910 may be omitted. When the checkbox 930 is in a checked state, in S235 of FIG. 4, the support app P2SA may generate the job ticket without using the sheet size selected via the menu 910.

In S320 and S335 of FIG. 5, instead of the class driver P2DV, the support app P2SA may transmit the job ticket and an image data set to the printer 100.

(4) A configuration of the print setting screen is not limited to the configurations of FIGS. 6A-6C and FIGS. 8A and B, and may be various other configurations. For example, an operation element for selecting printing at the document size may include a radio button. A selection part that represents a plurality of options including multiple media size options and an option indicating printing at the document size may include radio buttons.

(5) Extended functions provided by the support app P2SA may include various functions that are not included among functions provided by the standard driver such as the class driver P2DV. The support app P2SA may be a printer driver that operates independently of the class driver P2DV, and the support app P2SA may execute the printing process without using a function of the class driver P2DV.

(6) A total number of page images represented by image data may be any number of one or more.

(7) A total number of media sizes usable by the printer engine 160 may be any number of two or more. For example, the printer engine 160 may include three trays for three media sizes of A4, Letter, and A5. Further, as a medium, various sheets such as paper and film may be used.

(8) The communication method between the printer 100 and the terminal device 200 may be any method other than a method using the network NT. For example, the printer 100 and the terminal device 200 may communicate by short-range wireless communication such as Bluetooth (Registered Trademark) or Near Field Communication (NFC). The printer 100 and the terminal device 200 may communicate via a USB cable (not shown). The printer 100 and the terminal device 200 may communicate via a remote print server (not shown).

(9) The terminal device 200 may be a device different from a personal computer, such as a digital camera or a scanner. The scanner engine 170 may be omitted from the printer 100.

In the above embodiments, a part of the configuration realized by hardware may be replaced with software, and conversely a part or all of the configuration realized by software may be replaced with hardware. For example, processes executed by the printer processor 110 may be executed by dedicated hardware circuitry such as an Application Specific Integrated Circuit (ASIC).

When part or all of functions of the present disclosure are realized by a computer program, the program may be provided in a state stored on a non-transitory computer readable recording medium. The program may be used in a state stored on the same or on a different computer readable recording medium from that at the time of provision. The term “computer readable recording medium” is not limited to portable recording media such as a memory card or a CD ROM, and may also include an internal storage within a computer such as various ROMs and an external storage connected to a computer such as a hard disk drive.

The above embodiments and modifications can be combined as appropriate. The above embodiments and modifications are for facilitating understanding of the present disclosure and do not limit the invention. The invention can be changed and improved without departing from the spirit thereof, and equivalents are included within the scope of the invention.

What is claimed is:

1. A printing system comprising a terminal device and a printer,
wherein the terminal device comprises:
a display;
a display controller configured to cause the display to display a print setting screen configured to receive a print setting; and
a transmission controller configured to control transmission of image data to be printed and print setting information indicating the print setting to the printer,
wherein the transmission controller is configured to:
in a case where printing at a document size is selected on the print setting screen, generate the print setting information for printing at the document size, the document size being a media size associated with the image data without using the print setting screen, the print setting information not including information specifying a media size separately from the document size; and
in a case where printing at the document size is not selected on the print setting screen, generate the print setting information including size information indicating a media size set on the print setting screen,
wherein the printer comprises:
a printer engine; and
a printing controller configured to cause the printer engine to print an image represented by the image data,
wherein, in a case where the printer receives, from the terminal device, the image data and the print setting information for printing at the document size and the print setting information does not include the information specifying the media size, the printing controller causes the printer engine to print the image represented by the image data at the document size associated with the image data, and
wherein, in a case where the printer receives, from the terminal device, the image data and the print setting information including the size information indicating the media size set in the print setting screen, the printing controller causes the printer engine to print the image represented by the image data at the media size set in the print setting screen.

2. The printing system according to claim 1,
wherein the terminal device further comprises an acquisition unit configured to acquire capability information representing a capability of the printer related to printing from the printer, and
wherein, in a case where the capability information indicates that the printer is capable of executing the printing at the document size, the display controller allows selection of the printing at the document size on the print setting screen.

3. The printing system according to claim 1,
wherein the display controller causes the display to display the print setting screen including a checkbox for selecting the printing at the document size.

4. The printing system according to claim 3,
wherein the display controller causes the display to display the print setting screen including a size setting part configured to receive a setting of the media size, and
wherein, in a case where the printing at the document size is selected by the checkbox, the display controller disables the size setting part without deleting the size setting part.

5. The printing system according to claim 1,
wherein the display controller causes the display to display the print setting screen including a selection part allowing a user to select an option, the selection part representing a plurality of options including a plurality of media size options and an option indicating the printing at the document size.

6. The printing system according to claim 1,
wherein the print setting information for printing at the document size does not include the size information.

7. The printing system according to claim 1,
wherein transmission of the image data and the print setting information is performed by a transmitting process of the print setting information to the printer and a transmitting process of an image data set including the image data to the printer, and
wherein the document size is represented by the image data set.

8. The printing system according to claim 1,
wherein an operating system including a standard driver for printing and an application configured to provide an extended function for the standard driver have been installed in the terminal device, and
wherein the application, as the transmission controller, is configured to instruct the standard driver to transmit the image data and the print setting information to the printer.

9. A printing method comprising:
a display control step of causing a display of a terminal device to display a print setting screen configured to receive a print setting related to printing;
a transmission control step of controlling transmission of image data to be printed and print setting information indicating the print setting from the terminal device to a printer; and
a printing control step of causing a printer engine of the printer to print an image represented by the image data,
wherein, in a case where printing at a document size is selected on the print setting screen, the transmission control step includes generating the print setting information for printing at the document size, the document size being a media size associated with the image data without using the print setting screen, the print setting information not including information specifying a media size separately from the document size,
wherein, in a case where printing at the document size is not selected on the print setting screen, the transmission control step includes generating the print setting information including size information indicating a media size set on the print setting screen,
wherein, in a case where the printer receives, from the terminal device, the image data and the print setting information for printing at the document size and the print setting information does not include the information specifying the media size, the printing control step includes causing the printer engine to print the image represented by the image data at the document size associated with the image data, and
wherein, in a case where the printer receives, from the terminal device, the image data and the print setting information including the size information indicating the media size set in the print setting screen, the printing control step includes causing the printer engine to print the image represented by the image data at the media size set in the print setting screen.

10. A non-transitory computer-readable recording medium containing computer-executable instructions that are executable by a controller of a terminal device, the computer-executable instructions being configured to provide an extended function for a standard driver for printing included in an operating system, the computer-executable instructions being configured to, when executed by the controller, cause the terminal device to perform:
causing a display of the terminal device to display a print setting screen configured to receive a print setting related to printing; and
controlling transmission of image data to be printed and print setting information indicating the print setting to a printer,
wherein the computer-executable instructions are further configured to, when executed by the controller, cause the terminal device to perform:
in a case where printing at a document size is selected on the print setting screen, generating the print setting information for printing at the document size, the document size being a media size associated with the image data without using the print setting screen, the print setting information not including information specifying a media size separately from the document size; and
in a case where printing at the document size is not selected on the print setting screen, generating the print setting information including size information indicating a media size set on the print setting screen.
